(19) United States
(12) Patent Application Publication
(10) Pub. No.: US 2025/0038222 A1
(43) Pub. Date: Jan. 30, 2025

(54) BIPOLAR PLATE FOR AN ELECTROCHEMICAL SYSTEM AND CORRESPONDING ELECTROCHEMICAL SYSTEM COMPRISING SUCH A BIPOLAR PLATE

(71) Applicant: Reinz-Dichtungs-GmbH, Neu-Ulm (DE)

(72) Inventors: Bernd GAUGLER, Ulm (DE); Christian LUKSCH, Altenstadt (DE); Ahmet ORUC, Neu-Ulm (DE); André SPEIDEL, Bussmannshausen (DE); Stephan WENZEL, Pfaffenhofen (DE)

(21) Appl. No.: 18/785,881

(22) Filed: Jul. 26, 2024

(30) Foreign Application Priority Data
Jul. 28, 2023 (DE) 20 2023 104 277.5

(51) Int. Cl. H01M 8/0254; C25B 13/02; C25B 13/05; H01M 8/0206; H01M 8/0258; H01M 8/10; H01M 8/1004; H01M 8/18

(52) U.S. Cl. CPC H01M 8/0254; C25B 13/02; C25B 13/05; H01M 8/0206; H01M 8/0258; H01M 8/1004; H01M 8/188; H01M 2008/1095

(57) ABSTRACT

The present disclosure relates to a bipolar plate for an electrochemical system, having a first separator plate and a second separator plate that are arranged one on top of the other, wherein the first separator plate has, on a side facing away from the second separator plate, a first electrochemically active surface for conducting a first fluid; the second separator plate has, on a side facing away from the first separator plate, a second electrochemically active surface for conducting a second fluid; wherein the first electrochemically active surface and the second electrochemically active surface overlap each other and form an active region of the bipolar plate in an overlapping region, wherein the separator plates are joined together in the active region by a weld pattern with inhomogeneously distributed welds.

### CROSS REFERENCE TO RELATED APPLICATION

The present application claims priority to German Utility Model Application No. 20 2023 104 277.5, entitled “BIPOLAR PLATE FOR AN ELECTROCHEMICAL SYSTEM AND CORRESPONDING ELECTROCHEMICAL SYSTEM COMPRISING SUCH A BIPOLAR PLATE”, filed Jul. 28, 2023. The entire contents of the above-identified application is hereby incorporated by reference for all purposes.

### TECHNICAL FIELD

The present disclosure relates to a separator plate for an electrochemical system and to an electrochemical system comprising at least one such bipolar plate.

### BACKGROUND AND SUMMARY

Known electrochemical systems, for example fuel cell systems or electrochemical compressor systems, redox flow batteries and electrolyzers, usually comprise a large number of bipolar plates arranged in a stack so that every two adjacent bipolar plates enclose an electrochemical cell. The bipolar plates usually comprise two separator plates, which are connected to each other along their rear sides facing away from the electrochemical cells. The bipolar plates can be used, for example, for the electrical contacting of the electrodes of the individual electrochemical cells (e.g. fuel cells) and/or the electrical connection of neighboring cells (series connection of the cells).

The separator plates of the bipolar plates can have channel structures for supplying the cells with one or more media and/or for removing media. In the case of fuel cells, the media can be, for example, fuels (e.g. hydrogen or methanol), reaction gases (e.g. air or oxygen) or a coolant as supplied media and reaction products and heated coolant as discharged media. Furthermore, the bipolar plates can be used to conduct the waste heat generated in the electrochemical cell, for example during the conversion of electrical or chemical energy in a fuel cell, as well as to seal the various media or cooling channels off from each other and/or from the outside. In the case of fuel cells, the reaction media, i.e. fuel and reaction gases, are normally conducted on the mutually averted surfaces of the individual plates, while the coolant is conducted between the individual plates. The bipolar plates usually have at least one or more through-openings. Through the through-openings, the media and/or the reaction products can be fed to the electrochemical cells bounded by adjacent bipolar plates of the stack, or into the cavity formed by the separator plates of the bipolar plate, or can be discharged from the cells or from the cavity. The electrochemical cells in particular of a fuel cell may for example each comprise a membrane electrode assembly (or MEA) with a respective polymer electrolyte membrane (PEM) and electrodes. The MEA may also comprise one or more gas diffusion layers (GDL), which are normally oriented towards the separator plates, in particular towards bipolar plates of fuel cell systems, and are for example in the form of a carbon felt. In an example fuel cell, hydrogen carried on an anode side is typically converted to water with oxygen carried on a cathode side. Protons produced during the oxidation of hydrogen pass from the anode side through the MEA to the cathode, where they react with the oxygen and electrons to form water. The membrane of the fuel cell is electrically insulating and prevents an electrical short circuit between the anode and cathode. The electrons are guided separately from the anode to the cathode so that the electric current can be utilized.

Nowadays, most fuel cell systems are operated with an excess of oxidizing agent. It has been found that the reaction takes place to a greater extent at the points where there is a particularly high concentration of oxidation medium than at other points in the electrochemically active region. This can be the case, for example, in the immediate vicinity of entry points of the oxidizing agent into the electrochemically active region. The stronger conversion of reactants leads to a particularly high current density in the regions where there is a greater excess of oxidizing agent. This results in an uneven distribution of the current density over the active region. A high reactant conversion leads to a high load on the membrane, while the membrane only experiences a low load in regions of low material conversion. Overload regions have a negative effect on the service life of the MEA or its membrane. Low-load regions have the disadvantage of high area-related costs compared to output, especially as the MEA is a comparatively expensive component.

In other electrochemical systems, especially other polymer membrane-based electrochemical systems, other factors can lead to unequal loads on the surface of the polymer membrane.

It is therefore the object of the present disclosure to propose an improved bipolar plate and/or an improved electrochemical system, in particular in such a way that a service life of the bipolar plate and/or a service life of an MEA or polymer membrane arranged between bipolar plates in a bipolar plate stack is increased. Additionally or alternatively, the object may be to reduce the costs depending on the performance of an electrochemical system.

This object is solved by a bipolar plate and an arrangement for an electrochemical system according to the present disclosure.

The proposed bipolar plate for an electrochemical system has a first separator plate and a second separator plate, which are arranged on top of each other. The first separator plate has a first electrochemically active surface for conducting a first fluid on a side facing away from the second separator plate. The second separator plate has a second electrochemically active surface for conducting a second fluid on a side facing away from the first separator plate. The first electrochemically active surface and the second electrochemically active surface overlap each other and form an active region of the bipolar plate in an overlapping region. The separator plates are joined together in the active region by a weld pattern with inhomogeneously distributed welds.

In the present case, the term “first electrochemically active surface” is used to designate the surface of the first separator plate that is opposite an electrochemically active surface of the MEA when the separator plate is arranged in an electrochemical system. Similarly, the term “second electrochemically active surface” is used to designate the surface of the second separator plate that is opposite an electrochemically active surface of the MEA when the separator plate is arranged in an electrochemical system. In addition, it should be noted that when the present disclosure refers to “overlapping” or an “overlap” of the first electrochemically active surface with the second electrochemically active surface, an overlap of the surfaces in an orthogonal projection is meant. In an electrochemical system, the first electrochemically active surface can correspond in particular to a cathode side. The cathode side can, for example, have oxygen-conducting channels, i.e. for conducting in particular air or oxygen. The second electrochemically active surface can correspond in particular to an anode side. In particular, the anode side can have hydrogen-conducting channels, i.e. for conducting in particular hydrogen, methanol and/or another proton donor.

Surprisingly, it has been found that a defined, inhomogeneous distribution of the weld seams can enable a homogeneous current density or at least improved homogeneity of the current density over the electrochemically active region compared with a homogeneous distribution of the weld seams over the electrochemically active region. The weld seams can be distributed over the active region in such a way that there are fewer welds in regions where there would be overload areas if the weld seams were uniformly distributed. In addition or alternatively, the weld seams can be distributed over the active region in such a way that an areal density of welds is increased in regions where there would be low-load regions if the weld seams were uniformly distributed.

The welds may be arranged in the area of channels for conducting a first fluid and/or in the area of channels for conducting a second fluid, in particular in an orthogonal projection of the channel structures and/or welds onto a plane parallel to the plane of a separator plate. In one example, the welds are arranged in a contact area, which is an area in which the back side of a channel for conducting the first fluid rests on the back side of a channel for conducting the second fluid, in particular in a flat manner. This way a particularly durable and stable weld connection results.

A distance between neighboring welds can be greater in a first region of the weld pattern than in a second region of the weld pattern. The distances can be considered not only along a fluid channel, for example, but in all surface directions, i.e. perpendicular to the stacking direction of the electrochemical system.

This makes it easy to achieve an inhomogencous distribution of welds. The bipolar plate can have more than two regions, in particular whereby the welds within the respective regions can have a constant distance and the distances between the welds of the different regions are different.

In one embodiment, the first electrochemically active surface may have a first region and a second region. The welds can be distributed in such a way that an areal density of the welds in the first region, F1, is smaller than an areal density of the welds in the second region, F2. This means that regions that would otherwise react with a high current density due to a natural gradient of the reaction gases can become less heavily loaded regions through local electrical throttling, more precisely local throttling of the electron flow between the two separator plates of a bipolar plate. Additionally or alternatively, a current density in regions that would otherwise react with less current density due to a natural gradient of the reaction gases can be increased by locally reducing the electrical resistance.

The areal density of the welds can, for example, increase continuously or abruptly, in regular or irregular jumps, downstream of the fluid flow. The second region can be arranged downstream of the first region, for example downstream of the fluid flowing on the first surface of the cathode plate. The areal density can be defined, for example, as the ratio of the product of the weld seam length and the number of weld seams to the product of the channel length, channel spacing (“channel pitch”) and the number of webs spanned between the weld seams closest to each other at right angles to the direction in which the channel extends. In a narrower sense, this is a ratio of a length to an area, as the width of the weld seam has less influence on the electron flow in practice compared to its length and is usually constant for a bipolar plate.

When the term “downstream fluid flow” is used, it refers in particular to an overall flow direction that points from an inlet port to an outlet port. One, in particular local, direction of fluid flow in a channel of the flow field can deviate from the overall flow direction.

A ratio, F1/F2, between the areal density of the welds in the first region, F1, and the areal density of the welds in the second region, F2, can be less than 0.9, optionally less than 0.5. This can enable a particularly advantageous, especially homogeneous current density distribution across the electrochemically active region of the bipolar plate.

In one embodiment, a surface proportion of the first region and/or the second region in the total region of the active surface can be at least 5%, optionally at least 10%, optionally at least 15%, or optionally at least 25%. Additionally or alternatively, the first region and the second region can have the same area.

In one embodiment, the first electrochemically active surface may have a first region, a second region and a third region. The first region, the second region and the third region can be arranged one after the other in the direction of flow, for example of the first fluid, as mentioned above. The weld pattern can be designed in such a way that the areal densities of the welds in the aforementioned regions of the first electrochemically active surface deviate from each other by more than 5%, optionally by more than 10%, or optionally by more than 20%. This can allow for an advantageous, in particular more homogeneous, current density distribution.

In one embodiment, only the second region, or the second region and the first region, or the second region and the third region can have welds. In particular, the region in which reaction gases would react with a high current density if the welds were uniformly distributed can be electrically throttled by providing fewer or no welds, so that this region is less heavily loaded.

Within a channel or a group of channels, the areal density of the welds can initially increase and then decrease again, in the direction of flow in relation to the fluid flowing in the channel or to the fluid flowing on the other separator plate in a channel. The gradients can be arranged at different points in different channels in relation to the longitudinal extent of the flow field. Alternatively or additionally, weld patterns formed by the total number of welds can vary in different regions of the flow field depending on the distance from the side edges.

The bipolar plate may be arranged to be operated at a particular operating point of a fuel cell, wherein the particular operating point may comprise a particular concentration gradient of the first fluid along the first active surface. The weld pattern can be adapted to the concentration gradient of the first fluid, in particular so that an areal density of the welds in regions of the active surface with a comparatively low concentration of the first fluid is comparatively large and an areal density of the welds in regions of the active surface with a comparatively high concentration of the first fluid is comparatively small.

Alternatively, the material flows on both gas sides can also be optimized. The lowest density of welds can be provided in the regions where there is an excess of gas from both reactants. In regions where there is a shortage of at least one gas, a higher density of welds can be provided.

The first separator plate can have a first inlet port for letting in the first fluid and a first outlet port for discharging the first fluid. The first inlet port can be fluidically connected to the first electrochemically active region via a first inlet region. The first outlet port can be fluidically connected to the first electrochemically active region via a first outlet region, in particular so that the first fluid can be conducted successively through the first inlet region, the first electrochemically active region and the first outlet region.

The first and second separator plates can be connected to each other by further welds, which are arranged in the first inlet region and/or in the first outlet region. Furthermore, they can be tightly welded together along and at a distance from their edges.

In one embodiment, the bipolar plate can be designed in such a way that a flow direction of the first fluid is opposite to the flow direction of the second fluid. This embodiment may be referred to as a counterflow embodiment. The density of the welds in the second electrochemically active surface can decrease with the direction of flow of the second fluid and the density of the welds in the second electrochemically active surface can increase with the direction of flow of the first fluid.

In one embodiment, the bipolar plate can be designed in such a way that a flow direction of the first fluid is parallel to the flow direction of the second fluid. This embodiment may be designated as a direct current embodiment. The density of the welds in the second electrochemically active surface can increase with the flow direction of the first fluid and the second fluid.

In most cases, an attempt is made to achieve the most homogeneous possible fluid distribution transverse to the direction of flow through the design of the distribution or collection region. However, this is not always possible in an optimal way due to the interdependence of the fluid channels of all three fluid systems-especially in the case of fuel cell bipolar plates. In this case, it can be advantageous to ensure the most uniform possible current density and thus load on the membrane by means of inhomogeneous distribution of the welds transverse to the direction of flow, in particular perpendicular to the direction of flow.

To protect structural weak points of the membrane edges, regions with high current density can be shifted away from these edges towards a region of the active region that is oriented slightly towards the center. For this purpose, fewer welds can be provided at a cathode inlet region and/or in edge regions of the electrochemically active surface. This can lead to a throttling of the electron flow in these regions. Many welds can be provided in the region of the cathode outlet to promote the flow of electrons.

The welds of the weld pattern can be spaced apart from an outer edge of the active region. The distance between each weld and the outer edge can be greater than 1 mm and/or greater than 2 mm and/or greater than 5 mm and/or greater than 8 mm and/or greater than 10 mm, in particular greater than 15 mm. Additionally or alternatively, at least 1 channel and/or at least 2 channels and/or at least 4 channels and/or at least 8 channels and/or at least 10 channels can be arranged between each weld and the outer edge.

The first electrochemically active surface can be at least partly surrounded by a first scaling element of the first separator plate. The welds can be spaced apart from the first sealing element. A minimum distance between each weld and the sealing element can be greater than 5 mm, optionally greater than 8 mm, or optionally greater than 10 mm. The sealing element can be designed as an elastomer seal. Additionally or alternatively, the sealing element can be designed in particular as a bead seal. A minimum distance between each weld and the sealing element can be greater than 9 mm, optionally greater than 12 mm, or optionally greater than 14 mm, especially in the case of a bead seal.

Fewer weld seams or no welds at all in an edge region close to the bead can be advantageous, as springback of the separator plates at these points during production can lead to an offset between the anode and cathode, which can have a negative effect on weldability. Fewer welds in the edge region can therefore facilitate production and/or increase the quality of the bipolar plate in addition to or as an alternative to improved current density homogeneity.

Another aspect of the present disclosure relates to an arrangement for an electrochemical system comprising a bipolar plate as described above. The arrangement further comprises at least one membrane electrode assembly (MEA) with a frame-shaped reinforcing edge, wherein the MEA and the bipolar plate are arranged one on top of the other in a stacking direction and the active region of the first bipolar plate is enclosed by the reinforcing edge of the MEA in orthogonal projection in a common plane.

In one embodiment, the weld pattern of the bipolar plate may be spaced from the reinforcing edge in a direction perpendicular to the stacking direction by at least 2 mm, at least 5 mm, at least 8 mm, at least 10 mm or at least 15 mm. During operation of the arrangement as a fuel cell, a current density distribution of the bipolar plates can be homogeneous or at least more homogeneous than a current density distribution for similar bipolar plates that have a uniform distribution of welds over the active region.

In an area with the highest density of the welds within an active area of the bipolar plate, thus in particular a second or a third region of the welding pattern, the welds within a channel advantageously show a length and/or a distance between the closest welds between 0.05 mm and 3 mm, optionally between 0.1 mm and 1 mm, or optionally between 0.25 mm and 0.55 mm. In this respect, the length of the welds and their respective distance may have a difference of at the most 50%, or optionally at the most 20%. Within an area of highest density of the welds, for instance at the most four, optionally at the most three, or optionally at the most two channels may be situated between two welds which are closest to one another on a line which extends orthogonal or transverse, thus under an angle of more than 0° and less than 90°, to the main direction of extension of these channels. Even in a second or third region, at least one channel without welds may be arranged between two channels comprising welds. The closest welds do not necessarily need to be situated on a line extending orthogonal to the main direction of extension of the channels, they may also be shifted in this direction.

Exemplary embodiments of the separator plate and of the electrochemical system are illustrated in the figures and will be explained in more detail on the basis of the following description.

### BRIEF DESCRIPTION OF THE FIGURES

FIG. 1 schematically shows a perspective illustration of an electrochemical system comprising a plurality of separator plates or bipolar plates arranged in a stack.

FIG. 2 schematically shows a perspective illustration of two bipolar plates of the system according to FIG. 1 with a membrane electrode assembly (MEA) arranged between the bipolar plates.

FIG. 3 schematically shows a section through a plate stack of a system in the manner of the system according to FIG. 1.

FIG. 4 schematically shows a top view of a bipolar plate with evenly distributed welds according to the prior art.

FIG. 5 schematically shows a top view of an exemplary bipolar plate with unevenly distributed welds.

FIG. 6 schematically shows a top view of another exemplary bipolar plate with unevenly distributed welds.

FIG. 7 schematically shows a top view of another exemplary bipolar plate with unevenly distributed welds.

FIG. 8 schematically shows a top view of another exemplary bipolar plate with unevenly distributed welds.

FIG. 9 schematically shows a top view of another exemplary bipolar plate with unevenly distributed welds.

FIG. 10 schematically shows a top view of another exemplary bipolar plate with unevenly distributed welds.

FIG. 11 schematically shows a top view of a section of an active region of another exemplary bipolar plate with unevenly distributed welds.

FIG. 12 schematically a top view onto a section of a second or third area of an active area of a further exemplary bipolar plate.

### DETAILED DESCRIPTION

Here and below, features that recur in different figures are denoted in each case by the same or similar reference signs. In particular, the representation of the welds is greatly simplified and not to scale.

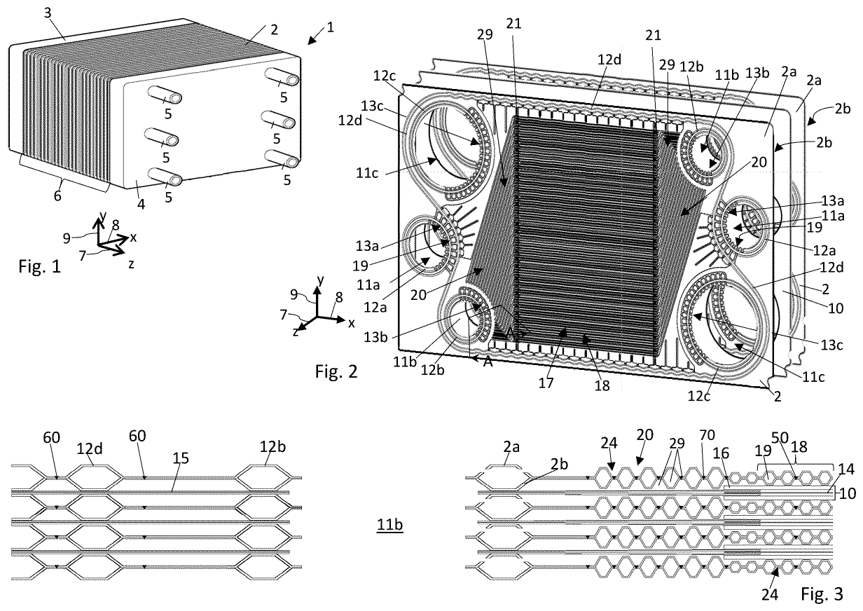

FIG. 1 shows an electrochemical system 1 comprising a plurality of structurally identical metal bipolar plates 2, which are arranged in a stack 6 and are stacked along a z-direction 7. The bipolar plates 2 of the stack 6 are clamped between two end plates 3, 4. The z direction 7 is also called stacking direction. In the present example, the system 1 is a fuel cell stack. In each case two adjacent bipolar plates 2 of the stack enclose between them an electrochemical cell which serves, for example, for conversion of chemical energy into electrical energy. In order to form the electrochemical cells of the system 1, a respective membrane electrode assembly (MEA) is arranged between adjacent bipolar plates 2 of the stack (see for example FIG. 2). The MEAs typically each contain at least one membrane, e.g. an electrolyte membrane. A gas diffusion layer (GDL) may also be arranged on one or both surfaces of the MEA (not illustrated in FIGS. 1 and 2).

In alternative embodiments, the system 1 may also be designed as an electrolyzer, as an electrochemical compressor, or as a redox flow battery. Bipolar plates can likewise be used in these electrochemical systems. The structure of these bipolar plates can then correspond to the structure of the bipolar plates 2 described in more detail here, even if the media fed onto or through the bipolar plate in an electrolyzer, in an electrochemical compressor or in a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, whereby the plate planes of the separator plates 2a, 2b are each aligned parallel to the x-y plane and thus perpendicular to the stacking direction or to the z-axis 7. The end plate 4 comprises a plurality of media connections 5, via which media can be fed to the system 1 and via which media can be discharged from the system 1. These media which can be supplied to the system 1 and carried out of the system 1 may comprise e.g. fuels such as molecular hydrogen or methanol, reaction gases such as air or oxygen, reaction products such as water vapor or depleted fuels or coolants such as water and/or glycol.

FIG. 2 shows, in a perspective view, two adjacent bipolar plates 2 of an electrochemical system of the same type as the system 1 from FIG. 1, as well as a membrane electrode assembly (MEA) 10, known from the prior art, which is arranged between these adjacent bipolar plates 2, the MEA 10 in FIG. 2 being largely obscured by the bipolar plate 2 facing towards the viewer. The bipolar plate 2 is formed of two separator plates 2a, 2b which are joined together by a material bond (see for example FIG. 3), of which only the first separator plate 2a facing towards the viewer is visible in FIG. 2, said first separator plate obscuring the second separator plate 2b. The separator plates 2a, 2b may each be manufactured from a metal sheet, for example from a stainless steel sheet. The separator plates 2a, 2b may for example be welded to one another, for example by laser welds. On the one hand, the separator plates 2a, 2b can be tightly welded along and at a distance from their outer edges or at least along the inner edge of a part of the through-openings along sealing seams 60, in particular outside and/or inside the perimeter bead 12d. Other weld seams are possible, which will be discussed below.

The separator plates 2a, 2b have through-openings, which are aligned with each other and form through-openings 11a-c of the bipolar plate 2. When a plurality of bipolar plates of the same type as the bipolar plate 2 are stacked, the through-openings 11a-c form lines which extend through the stack 6 in the stacking direction 7 (see FIG. 1). Typically, each of the lines formed by the through-openings 11a-c is fluidically connected to one of the media ports 5 in the end plate 4 of the system 1. By way of the lines formed by the through-openings 11a, it is possible for e.g. coolant to be introduced into the stack or discharged from the stack. By contrast, the lines formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are substantially parallel to the plate plane.

In order to seal off the through-openings 11a-c from the interior of the stack 6 and from the environment, the first separator plates 2a each have sealing arrangements in the form of scaling crimps 12a-c that are each arranged around the through-openings 11a-c and each fully enclose the through-openings 11a-c. The second separator plates 2b have corresponding sealing beads for sealing the through-openings 11a-c on the rear side of the separator plates 2 facing away from the viewer of FIG. 2 (not shown). Alternatively, elastomer seals can also be used.

In an electrochemically active region 18, the first separator plates 2a have a flow field 17 with structures for guiding a reaction medium along the outer side of the separator plate 2a on their outer side facing the viewer of FIG. 2. These structures are provided in FIG. 2 by a plurality of webs and channels which run between the webs and which are delimited by the webs. On the outer side of the bipolar plates 2 facing the viewer of FIG. 2, the first separator plates 2a also each have a distribution and collection region 20. Distribution or collection regions 20 in each case comprise structures which are configured to distribute a medium introduced proceeding from a first of the two through-openings 11b into the distribution region 20 over the active region 18 or to collect or combine a medium flowing proceeding from the active region 18 towards the second of the through-openings 11b. The fluid-guiding structures 29 of both distribution or collection regions 20 are likewise provided in FIG. 2 by webs and channels which run between the webs and which are delimited by the webs. In the following text, only the distribution region 20 will be discussed for the sake of simplicity; the corresponding statements can equally apply to a collection region 20.

The sealing beads 12a-12c have passages 13a-13c, of which the passages 13a are formed both on the underside of the upper separator plate 2a and on the upper side of the lower separator plate 2b, while the passages 13b are formed in the upper separator plate 2a and the passages 13c in the lower separator plate 2b. For example, the passages 13a, which are designed as localized elevations of the bead, allow coolant to pass between the through-opening 12a and the distribution region 20, so that the coolant enters the distribution region between the bipolar plates or is led out of the collection region 20. Furthermore, the passages 13b allow a passage of hydrogen between the through-opening 12b and the distribution region on the upper side of the separator plate 2a lying on top, these passages 13b are characterized by perforations facing the distribution region and running at an angle to the plate plane. For example, hydrogen flows through the passages 13b from the through-opening 12b to the distribution region on the top of the separator plate 2a or in the opposite direction from the collection region. The passages 13c allow a passage of, for example, air between the through-opening 12c and the distribution region, so that air enters the distribution region on the underside of the separator plate 2b lying below or is led out of the collection region. The associated perforations are not visible here.

The first separator plates 2a also each have a further sealing arrangement in the form of a perimeter bead 12d, which surrounds the flow field 17 of the active region 18, the distribution and collection areas 20 and the through-openings 11b, 11c and seals these off from the through-opening 11a, i.e. from the coolant circuit, and from the environment of the system 1. The second separator plates 2b each comprise corresponding peripheral beads. The structures of the active region 18, the distribution structures of the distribution and collection region 20 and the sealing beads 12a-d are each formed in one piece with the separator plates 2a and molded into the separator plates 2a, e.g. in an embossing or deep-drawing process or by means of hydroforming. The same applies to the corresponding structures of the second separator plates 2b.

The two through-openings 11b or the lines through the plate stack of the system 1 that are formed by the through-openings 11b are each fluidically connected to one another via passages 13b in the sealing beads 12b, via the distributing structures of the distribution or collection region 20 and via the flow field 17 in the active region 18 of the first separator plates 2a facing towards the viewer of FIG. 2. In an analogous manner, the two through-openings 11c or the lines formed by the through-openings 11c through the plate stack of the system 1 are in fluid connection with each other in each case via corresponding bead passages, via corresponding distribution and collection structures and via a corresponding flow field on an outer side of the second separator plates 2b facing away from the viewer of FIG. 2. In contrast, the through-openings 11a or the lines through the plate stack of the system 1 that are formed by the through-openings 11a are each fluidically connected to one another via a cavity 19 that is enclosed or surrounded by the separator plates 2a, 2b. Each cavity 19 serves to guide a coolant through the bipolar plate 2, in particular to cool the electrochemically active region 18 of the bipolar plate 2.

FIG. 3 schematically shows a section through a portion of the plate stack 6 of the system 1 from FIG. 1, the section plane being oriented in the z-direction and thus perpendicular to the plate planes of the bipolar plates 2. In FIG. 3, the sectional plane runs along a bent section, along the sectional line A-A in FIG. 2.

The identically constructed bipolar plates 2 of the stack each comprise the first metallic separator plate 2a previously described and the second metallic separator plate 2b previously described. Structures for guiding media along the outer surfaces of the separator plates 2, here in particular in each case in the form of webs and channels delimited by the webs, are apparent. In particular, channels are shown on the surfaces of adjacent separator plates 2a, 2b pointing away from each other, as well as cooling channels in the cavity 19 between adjacent separator plates 2a, 2b. Adjacent to the sealing bead 12d and between the cooling channels both in the distribution or collection region 20 and in the active region 18, the two separator plates 2a, 2b lie on top of each other in a contact region 24 and are connected to each other there, in the present example by means of laser weld seams 60, 70, 50.

A respective membrane electrode assembly (MEA) 10 known for example from the prior art is arranged between adjacent separator plates 2 of the stack. The MEA 10 typically comprises a membrane, e.g. an electrolyte membrane, and an edge portion 15 connected to the membrane 14. For example, the edge portion 15 can be bonded to the membrane 14, e.g. by an adhesive connection or by lamination.

In the present case, the term “first electrochemically active surface” is used to designate the surface of the first separator plate 2a, 2b that is opposite an electrochemically active surface of the MEA 10 when the separator plate 2a is arranged in an electrochemical system. The membrane of the MEA 10 extends in each case at least over the active region 18 of the adjacent separator plates 2 and enables a proton transfer there over or through the membrane 14. The actual active region 18 is limited by the edge portion 15 of the MEA. This means that the membrane does not extend into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining bipolar plates 2. The edge portion 15 can also extend outwards beyond the perimeter bead 12d and adjoin or protrude beyond the outer edge region of the separator plates 2a, 2b (see FIG. 2).

Furthermore, gas diffusion layers 16 may additionally be arranged in the active region 18. The gas diffusion layers 16 enable direct flow to the membrane over the greatest possible region of the surface of the membrane and can thus improve the transfer of protons via the membrane. The gas diffusion layers 16 can, for example, be arranged on both sides of the membrane at least in the active region 18 between the adjacent bipolar plates 2. The gas diffusion layers 16 may, for example, be formed from a fiber felt or comprise a fiber felt.

While in FIG. 2 an outer side of a bipolar plate 2 that carries hydrogen during operation, i.e. an anode plate, is facing the viewer, the following illustrations show an outer side that carries oxygen, i.e. the cathode plate of the bipolar plate 2, facing the viewer.

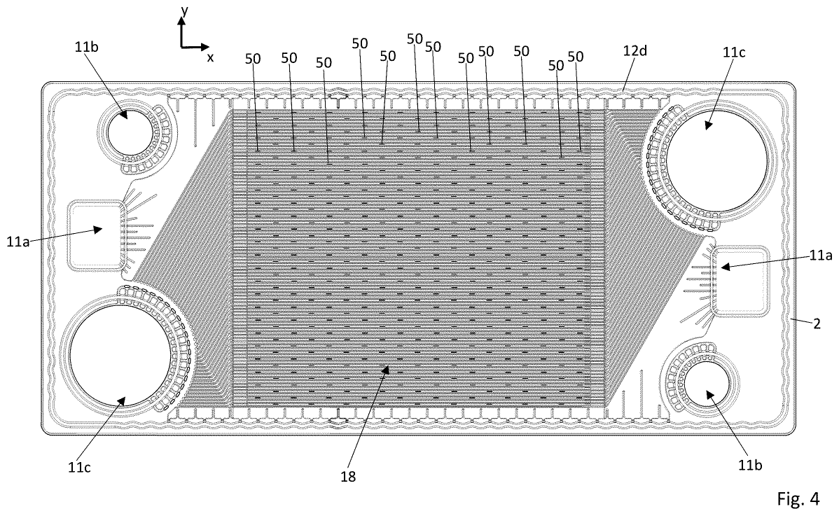

FIG. 4 shows a plan view of a bipolar plate 2 of an electrochemical system of the type of system 1 in FIG. 1. The bipolar plate has a plurality of welds 50, only some of which are marked with reference symbols for the sake of clarity. The plurality of welds 50 results in a weld pattern. In the prior art, the welds 50 are homogeneous, i.e. evenly distributed over the active region 18 of the bipolar plate 2 of FIG. 4. Such a homogeneous distribution of the weld seams can have the disadvantage that a current density during operation of the bipolar plate is distributed inhomogeneously over the active region due to the natural gradients of the reaction gases. This can lead to overload regions and thus a reduced service life of the MEA or its membrane and/or low-load regions with reduced performance.

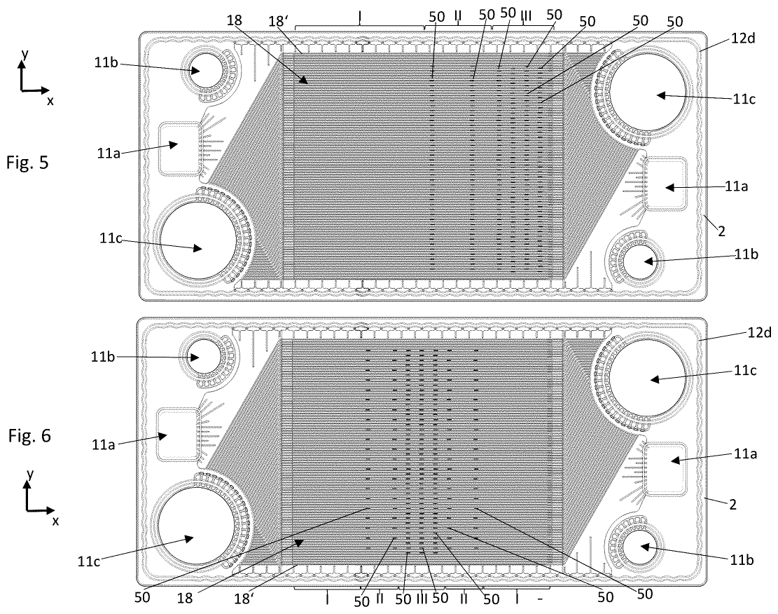

In contrast, the present disclosure provides for an inhomogeneous distribution of the welds 50 in the active region 18, as shown in the examples of FIGS. 5 to 11.

FIG. 5 shows a plan view of a bipolar plate 2 of an electrochemical system of the type of system 1 in FIG. 1. In the embodiment of the bipolar plate shown in FIG. 5, the bipolar plate is designed in such a way that a flow direction of the first fluid is parallel to the flow direction of the second fluid. In the image plane shown, the first fluid flows from left to right. The areal density of the welds in the first electrochemically active surface increases with the direction of flow of the first fluid. The active region 18 is limited by its outer edge 18′. In particular, no weld 50 is located in a first region I. In a second region II, an areal density F1 of the welds 50 is less than an areal density F2 of the welds in a third region III. A ratio, F1/F2, between the areal density F1 of the welds in the second region II and the areal density F2 of the welds in the third region III is less than 0.9, optionally less than 0.5. This allows for a particularly advantageous, especially homogeneous current density distribution across the electrochemically active region 18 of the bipolar plate. In the second region II, two rows of welds running in the y-direction are provided in this example. The welds each extend in the x-direction. The welds 50 of the first row are located in the same channels as the welds 50 of the second row. The distance between a weld 50 of the first row and the nearest weld 50 of the second row is the same for all welds 50 of the first row. Between channels in which welds 50 are provided, there is at least one channel in which no weld 50 is provided. In the third region III, four rows of welds 50 are provided in the y-direction in this example. The welds 50 each extend in the x-direction. The welds 50 of the first row are located in the same channels as the welds of the third row. The welds 50 of the second row are located in the same channels as the welds of the fourth row. The distance between a weld 50 of one row and the nearest weld 50 of the next row is the same for all welds 50 of the respective row. At least two welds 50 are arranged in each channel of the parallel channels of the active region 18. Due to the arrangement of the welds 50 in this way, a current density of the bipolar plate shown in FIG. 5 is more homogeneously distributed when used in an electrochemical system according to FIGS. 1-3 than when bipolar plates according to FIG. 4 are used. In the first region I, the current density can be reduced compared to the current density of the bipolar plate in FIG. 4. At least in the third region, the current density can be increased compared to the current density of the bipolar plate in FIG. 4.

FIG. 6 shows a plan view of a bipolar plate 2 of an electrochemical system of the type of system 1 in FIG. 1. In the embodiment of the bipolar plate shown in FIG. 6, it is designed in such a way that a flow direction of the first fluid is opposite to a flow direction of the second fluid. In the image plane shown, the first fluid flows from left to right. The second fluid flows from right to left. A reverse fluid direction would also be possible in each case. The density of the welds in the first electrochemically active surface first increases and then decreases again with the direction of flow of the first fluid. In particular, no weld 50 is located in two first regions I. In two second regions II, which lie between the two first regions, an areal density F1 of the welds 50 is smaller than an areal density F2 of the welds in a third region III. The third region III lies between the two second regions II. The regions II and III are arranged centrally between the regions I. A ratio F1/F2 between the areal density F1 of the welds in the second region II and the areal density F2 of the welds in the third region III is less than 0.9, optionally less than 0.5. This enables a particularly advantageous, especially homogeneous current density distribution across the electrochemically active region 18 of the bipolar plate 2 when it is operated in countercurrent. In each of the second regions II, two rows of welds 50 running in the y-direction are provided in the present example. The welds 50 each extend in the x-direction. The welds 50 of the first row are located in the same channels as the welds 50 of the second row of the respective second region. The distance between a weld 50 of the first row and the nearest weld 50 of the second row is the same for all welds 50 of the first row. Between channels in which welds 50 are provided, there are three channels in which no weld 50 is provided. In the third region, three rows of welds 50 are provided in the y-direction in this example. The welds 50 each extend in the x-direction. The welds 50 of all three rows are located in the same channels. The first row of welds 50 of the third region has the same distance to the second row of the second region II as the first row of welds 50 of the first row of the second region II has to the second row of welds of the second region II. Due to the arrangement of the welds 50 in this way, a current density of the bipolar plate shown in FIG. 6 is more homogeneously distributed when used in an electrochemical system according to FIGS. 1-3 than when bipolar plates according to FIG. 4 are used. In the first region I, the current density can be reduced compared to the current density of the bipolar plate in FIG. 4. At least in the third region, the current density can be increased compared to the current density of the bipolar plate in FIG. 4. In the second region, the welds 50 are spaced apart from an outer edge 18′ of the active region 18.

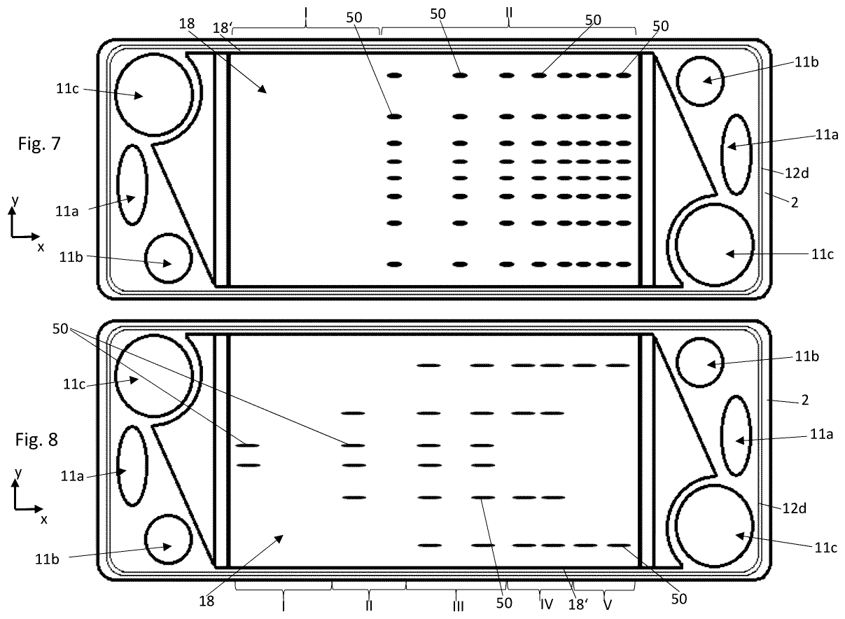

FIGS. 7 to 10 show top views of bipolar plates 2 in considerably simplified form compared with FIGS. 4 to 6. In particular, the welds 50 are not depicted to scale. It should also be noted that the arrangement of the through-openings differs between figure groups 4 to 6 and 7 to 10.

FIG. 7 shows a top view of a further example of a schematically depicted bipolar plate 2 of an electrochemical system of the type of system 1 in FIG. 1. In the embodiment of the bipolar plate 2 shown in FIG. 7, it is designed in such a way that a flow direction of the first fluid is parallel to a flow direction of the second fluid. While no welds 50 are provided in a first region I, the areal density of the welds 50 gradually increases in the direction of flow in a second region. No welds 50 are provided in the edge regions of the active region 18 in order to improve production and reduce stress on the outer regions of the active surface of the membrane. At least 2 channels are arranged between each weld 50 and the outer edge 18′ of the active region 18. A distance between each weld and the outer edge of the bipolar plate 2 is greater than 15 mm. A distance between each weld and the perimeter bead 12d is greater than 10 mm.

FIG. 8 shows a top view of a further example of a schematically depicted bipolar plate 2 of an electrochemical system of the type of system 1 in FIG. 1. In the embodiment of the bipolar plate 2 shown in FIG. 8, it is designed in such a way that a flow direction of the first fluid is parallel to a flow direction of the second fluid. While only two welds 50 arranged one above the other in the y-direction are provided in a first region I, four welds 50 arranged centrally one above the other are provided in a second region II. In a third region III, two rows are provided, each with six welds 50 arranged centrally one above the other. A fourth region IV corresponds to the third region III, whereby two central welds of each row are omitted. A fifth region V corresponds to the fourth region IV, whereby two central welds 50 of each row are again omitted. This creates a weld pattern that resembles a “<” sign in the top view shown. The distances between the weld seams 50 of each row running in the y-direction increase from the center towards the upper and lower outer edges, “upper” and “lower” referring to the image in FIG. 8. The distances between the weld seams 50 of the row running in the x-direction decrease from left to right, “left” and “right” referring to the illustration in FIG. 8. At least four channels are arranged between each weld 50 and the outer edge 18′ of the active region 18.

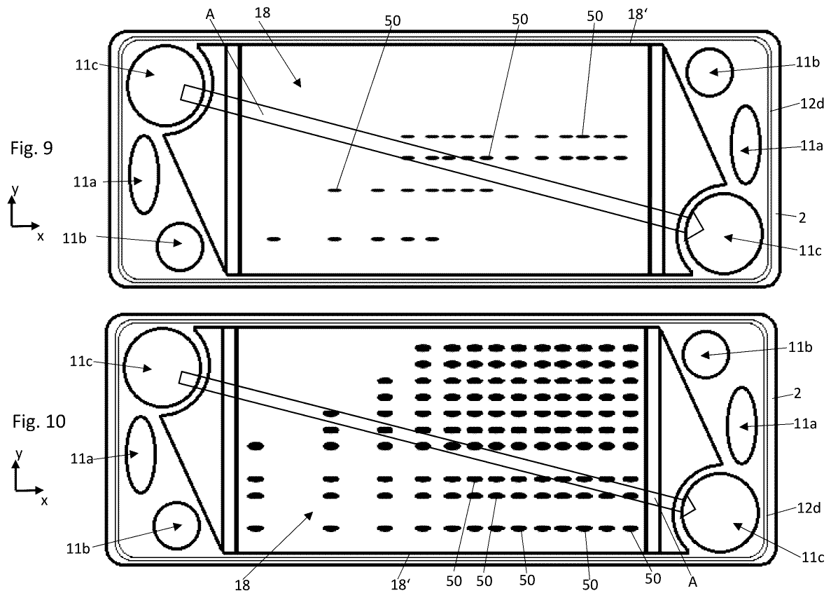

FIG. 9 shows a top view of a further example of a schematically depicted bipolar plate 2 of an electrochemical system of the type of system 1 in FIG. 1. The arrow A marks a concentration gradient of the fluid, which is directed from the through hole 11c (located at the top left in FIG. 9) into the distribution region via the active region 18 to the through hole 11b (located at the bottom right in FIG. 9). The exemplary weld pattern has four rows of welds 50 running in the x-direction. The first three rows are offset from each other and arranged parallel to the x-axis. The fourth row corresponds to the third row and is arranged above the third row. Within the first row and within the second row, the distance between the welds decreases unevenly. The number and spacing of the welds 50 in the first and second row differ from each other. Within the third and fourth row, the distance between the welds initially decreases, then increases again and then decreases again. The weld pattern in FIG. 9 only has welds 50 in the upper 2/3 of the active region 18. An arrangement of the welds as shown in FIG. 9 can be particularly advantageous if, on the one hand, the lowest region of the active region has an undersupply of media, while the upper region is sufficiently supplied everywhere and, on the other hand, the middle region (in relation to the height) has a below-average current density, at least in the part downstream of the fluid flow, without countermeasures. In the regions where there are no weld seams, the current density during operation of the bipolar plate 2 can be lower than that of a bipolar plate as shown in FIG. 4. A current density can be increased in regions with welds 50. The distance between each weld 50 and the outer edge 18′ of the active region 18 is at least 10 mm.

FIG. 10 shows a top view of a further example of a schematically depicted bipolar plate 2 of an electrochemical system of the type of system 1 in FIG. 1. The arrow A marks a direction of flow of the fluid from the through hole 11c (located at the top left in FIG. 10) into the distribution region, via the active region 18 to the through hole 11c (located at the bottom right in FIG. 10). First of all, an embodiment of the bipolar plate 2 was manufactured, which was provided with evenly spaced welded joints in the active region 18 similar to FIG. 4. Based on this, the current density distribution was determined, which showed that the current density was higher in the upper left region of active region 18 than in other regions. Furthermore, a higher current density distribution was found in the left-hand regions than in the right-hand regions. In addition, two predominantly horizontal regions running at a distance from each other in the lower third showed an excessively high current density. Based on this result, the original weld pattern was only reused in a rectangular region at the top right for the present panel 2. The remaining distribution or areal density of the weld seams results from the previously obtained measured values and compensates for the excessively high current densities with its inhomogeneous distribution. The distance between each weld 50 and the outer edge 18′ of the active region 18 is at least 5 mm.

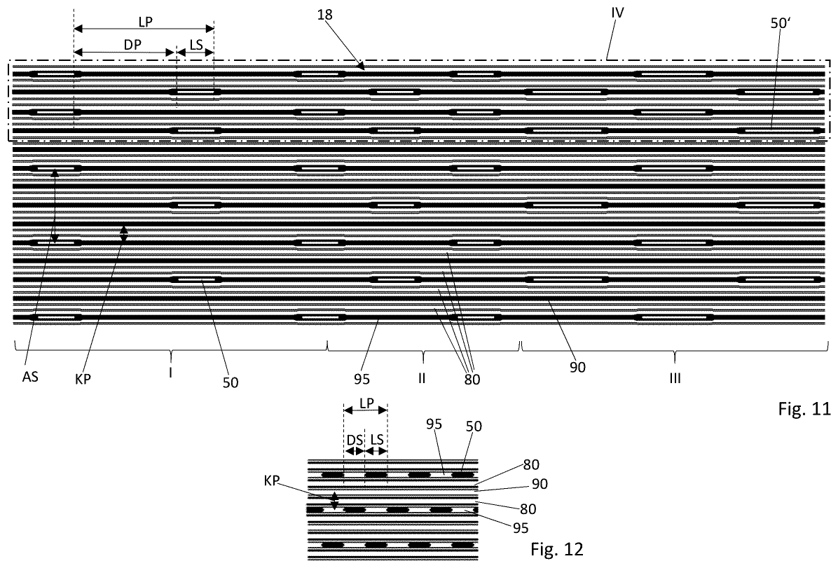

FIG. 11 shows a section of an active region 18 of a bipolar plate 2. In order to ensure sufficient contact surface for welding, the duct base or channel base is widened here in the region of the welds 50 (shown here in white) compared to the adjacent duct sections, unlike in the previous embodiment examples. FIG. 11 also shows the parameters from which the areal density can be derived. This can be defined, for example, as the ratio of the product of the weld seam length LS and the number of weld seams to the product of the channel length, channel spacing (“channel pitch”) KP and the number of spanned webs 80—four in this example on a line extending at right angles to the direction in which the channel extends and two in this example on a line extending transverse, thus under an angle of more than 0° but less than 90°, to the direction in which the channels extend—between two weld seams closest to each other. The areal density determined in this way is, in a narrower sense, a ratio of a length to an area, as the width of the weld seam has less influence on the electron flow in practice compared to its length and is usually constant for a bipolar plate. The duct length can be measured in its entirety, but it can also be determined by the distance between the weld seams DP or the sum of weld length LS and distance DP expressed as LP in the main direction of duct extension and the number of welds. As an alternative to determining the channel pitch, the distance between the welds transverse to the main direction of channel extension can also be measured directly as AS.

FIG. 11 also illustrates that the areal density of the welds can be varied by the distance between the welds in the direction of the channel extension, as the comparison of regions I and II shows. On the other hand, it can be changed via the length of the weld seams, as the comparison of the first two regions I, II with region III shows. In the dotted line framed region IV, the areal density of the welds is not homogeneous, but shows the previously described ratio of regions I, II and III in the horizontal course. However, twice the areal density of welds is achieved here in the vertical course as outside this dotted line framed region IV due to the fact that welded joints 50 are present not only in every second channel, but in every channel.

FIG. 12 schematically shows a top view onto a section of an active area of a further exemplary bipolar plate. The figure shows a second or a third region of an active area, in which a considerably high density of weld seams is given. The welds 50 here show a length LS, e.g. 0.25 mm, which corresponds essentially to the distance between the end of the weld and the beginning of the closest weld within the same channel 95. As in the previous example, a channel 90 without welds is given between two welds 50 being closest to one another in a direction transverse to the main extension direction of the channels 90. When considering the welds 50, which are closest to one another on a line extending at right angles to the main extension direction of the channels, then three channels and four webs are given between these welds. Among these channels are two channels 90 without welds and one channel 95 with welds.

1. A bipolar plate for an electrochemical system, having a first separator plate and a second separator plate that are arranged one on top of the other, wherein
the first separator plate has, on a side facing away from the second separator plate, a first electrochemically active surface for conducting a first fluid;
the second separator plate has, on a side facing away from the first separator plate, a second electrochemically active surface for conducting a second fluid;
wherein the first electrochemically active surface and the second electrochemically active surface overlap each other and form an active region of the bipolar plate in an overlapping region,
wherein the first separator plate and the second separator plate are joined together in the active region by a weld pattern with inhomogeneously distributed welds.

2. The bipolar plate according to claim 1, wherein a distance between adjacent welds in a first region of the weld pattern is greater than in a second region of the weld pattern.

3. The bipolar plate according to claim 1, wherein the first electrochemically active surface comprises a first region and a second region,
wherein the welds are distributed such that an areal density of the welds in the first region, F1, is smaller than an areal density of the welds in the second region, F2.

4. The bipolar plate according to claim 3, wherein a ratio, F1/F2, between the areal density of the welds in the first region, F1, and the areal density of the welds in the second region, F2, is less than 0.9.

5. The bipolar plate according to claim 3, wherein a surface proportion of the first region and/or the second region in each case amounts to at least 5% of a total area of the active region and/or wherein the first region and the second region have the same area.

6. The bipolar plate according to claim 1, wherein the first electrochemically active surface comprises a first region, a second region and a third region, wherein the second region is arranged between the first region and the third region with respect to a flow direction of a fluid,
wherein the weld pattern is configured such that areal densities of the welds in the said regions of the first electrochemically active surface deviate from one another by more than 5%.

7. The bipolar plate according to claim 6, wherein only the second region, or the second region and the first region, or the second region and the third region have welds.

8. The bipolar plate according to claim 1, wherein the welds are arranged in an area of channels for conducting the first fluid and/or in an area of channels for conducting the second fluid.

9. The bipolar plate according to claim 1, wherein the welds of the weld pattern are spaced from an outer edge of the active region, wherein a distance between each weld and the outer edge is greater than 2 mm.

10. The bipolar plate according to claim 1, wherein the welds of the weld pattern are spaced apart from an outer edge of the active region, wherein at least 1 channel is arranged between each weld and the outer edge.

11. The bipolar plate according to claim 1, wherein the first electrochemically active surface is at least partly surrounded by a first sealing element of the first separator plate and the welds are spaced apart from the first sealing element, wherein a minimum distance between each weld and the first sealing element is greater than 5 mm.

12. The bipolar plate according to claim 1, wherein the bipolar plate is adapted to be operated at a particular operating point of a fuel cell, wherein the particular operating point comprises a particular concentration gradient of the first fluid along the first electrochemically active surface,
wherein the weld pattern is adapted to the concentration gradient of the first fluid, so that a first areal density of the welds in regions of the active region of comparatively low concentration of the first fluid is comparatively large and a second areal density of the welds in regions of the active region of comparatively high concentration of the first fluid is comparatively small.

13. The bipolar plate according to claim 1, wherein the first separator plate comprises a first inlet port for letting in the first fluid and a first outlet port for discharging the first fluid,
wherein the first inlet port is fluidically connected to the first electrochemically active surface via a first inlet region and the first outlet port is fluidically connected to the first electrochemically active surface via a first outlet region such that the first fluid can be passed successively through the first inlet region, the first electrochemically active surface and the first outlet region,
wherein the first separator plate and the second separator plate are connected to one another by further welds, which are arranged in the first inlet region and/or in the first outlet region.

14. The bipolar plate according to claim 1, designed such that a flow direction of the first fluid is opposite to a flow direction of the second fluid, wherein an areal density of the welds in the second electrochemically active surface decreases with the flow direction of the second fluid and the areal density of the welds in the second electrochemically active surface increases with the flow direction of the first fluid.

15. The bipolar plate according to claim 1, configured such that a flow direction of the first fluid is parallel to a flow direction of the second fluid, wherein an areal density of the welds in the second electrochemically active surface increases with the flow direction of the first fluid and the flow direction of the second fluid.

16. The bipolar plate according to claim 1, wherein the first separator plate is a cathode plate and the second separator plate is an anode plate, wherein the first fluid is oxygen or air and/or the second fluid is hydrogen, methanol or another proton donor.

17. The bipolar plate according to claim 1, wherein within a channel, at least in sections, a length of the welds and/or a distance between welds being closest to one another is between 0.05 mm and 3 mm.

18. The bipolar plate according to claim 1, wherein in sections, at the most four channels are situated between two welds being closest to one another on a line extending orthogonal or traverse to a main extension direction of a channel.

19. An arrangement for the electrochemical system having the bipolar plate according to claim 1 and at least one membrane electrode assembly (MEA) with a frame-shaped reinforcing edge, the MEA and the bipolar plate being arranged one on top of the other in a stacking direction and the active region of the bipolar plate being enclosed in orthogonal projection in a common plane by the frame-shaped reinforcing edge of the MEA.

20. The arrangement according to claim 19, wherein the weld pattern of the bipolar plate is spaced from the frame-shaped reinforcing edge in a direction perpendicular to the stacking direction by at least 2 mm.
